(19) United States
(12) Patent Application Publication
(10) Pub. No.: US 2005/0053022 A1
(43) Pub. Date: Mar. 10, 2005

(54) Encoding and merging multiple data streams of fibre channel network

(75) Inventor: Robert N. Zettwoch, St. Charles, MO (US)

Correspondence Address: SENNIGER POWERS LEAVITT AND ROEDEL, ONE METROPOLITAN SQUARE, 16TH FLOOR, ST LOUIS, MO, 63102, US

(73) Assignee: The Boeing Company

(21) Appl. No.: 10/745,045

(22) Filed: Dec. 23, 2003

Related U.S. Application Data
(63) Continuation-in-part of application No. 10/650,597, filed on Aug. 28, 2003.

(51) Int. Cl. H04L 5/22

(52) U.S. Cl. 370/299

(57) ABSTRACT

A method of combining multiple data streams of a Fibre Channel network by encoding the first, second or more data streams of the Fibre Channel network and merging the encoded first, second or more data streams into a plurality of frames. The encoding comprises creating packets of information from each of the first, second or more data streams and adding (inserting) identification information to each of the plurality of PCM frames.

The invention generally relates to a method of capturing multiple data streams or channels of a Fibre Channel network. In particular, the invention relates to a method of encoding and merging multiple data streams received by a Fibre Channel interface unit into pulse code modulated (PCM) frames so that standard PCM recording, telemetry and decommutator devices may be used to process the data streams.

### BACKGROUND OF THE INVENTION

In many applications, electronic equipment is interconnected and communicates with each other via a network. An example of electronic equipment interconnected in a network includes avionics, such as a radar system, on an aircraft. To accommodate performance enhancements and their associated increases in data requirements, advanced systems may include a Fibre Channel network. Each node of the network can simultaneously transmit and receive according to a full duplex transmit-receive protocol. For example, each data word may include 32 bits and each frame up to 528 data words. Each frame is part of a sequence and these sequences can be part of different exchanges. Therefore, one frame is out of context without the other frames from the same sequence of an exchange.

Fibre Channel networks may include switches to enable communication paths to occur simultaneously between two nodes, such as a four port Fibre Channel switch. With multiple switches, multiple paths can be found and, therefore, variable frame delays may result.

There is a need for a method for permitting monitoring and recording of such frames of data communicated with a Fibre Channel network. In addition, there is already a large infrastructure in many military, space, commercial and industrial applications with the capability to recover or unwrap packaged PCM data from telemetry devices and recorders. Thus, there is a need for a serial method of transferring data from a Fibre Channel so that it can be telemetered and without reserializing the data streams.

### SUMMARY OF THE INVENTION

The present invention provides a method of encoding and merging multiple data streams received by a Fibre Channel interface unit into pulse code modulated (PCM) frames so that standard PCM recording, telemetry and decommutator devices may be used to process the data streams.

According to one exemplary non-limiting embodiment of the present invention, a method of combining multiple data streams of a Fibre Channel network is provided. The first and second data streams of the Fibre Channel network are encoded. The encoded first and second data streams are merged into a plurality of frames.

According to another exemplary non-limiting embodiment of the present invention, a method of combining multiple data streams of a Fibre Channel network is provided. Packets of information are created from each of the first and second data streams by: capturing words of each of the data streams; determining a content of each of the captured words; and formatting each of the captured words according to its determined content. The encoded first and second data streams are merged into a plurality of frames. Identification information is added to each of the frames.

According to another exemplary non-limiting embodiment of the present invention, a method of combining multiple data streams of a Fibre Channel network is provided. The method comprises creating packets of information from each of the first and second data streams, merging the encoded first and second data streams into a plurality of frames, and adding identification information to each of the frames. Adding identification information includes at least one of the following: inserting a sync pattern into each of the frames; inserting an increment frame counter into each of the frames; inserting a current time into each of the frames; and inserting encoding information into each of the created frames.

According to another exemplary non-limiting embodiment of the present invention, a method of combining multiple data streams of a plurality of avionics units networked with a Fibre Channel network having nodes is provided. At least one node has an interface for transmitting at least some of the multiple data streams. The transmitted multiple data streams of the at least one node of the Fibre Channel network is encoded. The encoded multiple data streams are merged into a plurality of frames.

### BRIEF DESCRIPTION OF THE DRAWINGS

FIG. 1 is a block diagram of portions of an exemplary embodiment of a Fibre Channel interface unit in combination with a PCM frame generator according to the invention.

FIG. 2 is a flow chart of a method of creating packets according to the invention.

FIG. 3 is a flow chart of a method of adding PCM identification information according to the invention.

### DETAILED DESCRIPTION OF THE INVENTION

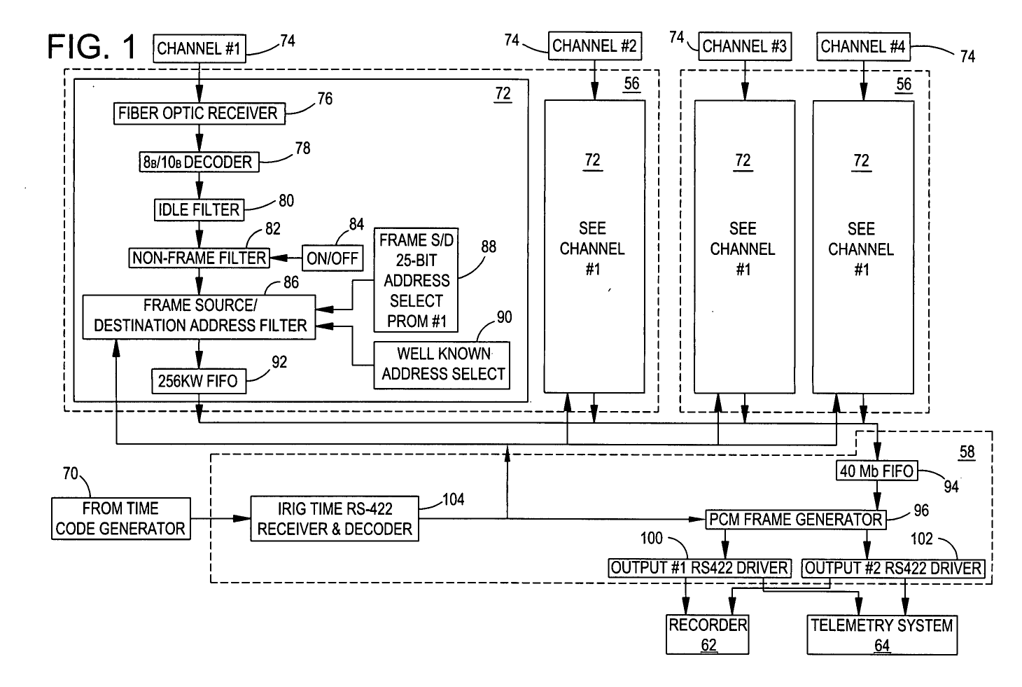

Referring now to FIG. 1, details are provided regarding a Fibre Channel interface unit (FCIU) 50 for implementing one embodiment of the invention. For example, in one exemplary embodiment of the invention, there is provided a method of combining multiple data streams of a plurality of avionics units networked with a Fibre Channel network having nodes, at least one node associated with the interface unit 50 for transmitting at least some of the multiple data streams. In this one embodiment, the interface unit 50 may receive up to 4 fiber optic Fibre Channel inputs. The input interface 56 may include two channels on one board. Therefore, in one embodiment, two input interfaces 56 are provided for receiving up to four input channels. Details of each input channel 72 are set forth below.

A termination 74 couples the input interface 56 to the node of the Fibre Channel network. A fiber optic receiver 76 is coupled to the termination 74 to receive input signals from the node. In one embodiment, the receiver 76 may be a stand-alone receiver. However, in another embodiment, the receiver 76 is part of a transceiver. Any acceptable receiver or transceiver may be used for the receiver 76 for receiving data words having characteristics as set forth above. Given by way of non-limiting example, an acceptable receiver includes a Finisar FTRJ-8519-1 receiver. A decoder 78 is coupled to the receiver 76. The decoder 78 performs standard 8B/10B decoding.

An idle filter 80 is coupled to the decoder 78. The idle filter 80 filters, that is removes, all idle primitive signals. As is known, idle primitive signals are placed on buses even when no information content is included in the signals in order to keep components in receivers synchronized or locked together.

A non-frame filter 82 filters primitive signals and sequences (other than idles). The primitive signals and sequences are not part of a frame. The primitive signals and sequences are filtered by the non-frame filter 82 on an all-or-none basis as enabled by a block 84.

Advantageously, an address filter 86 filters Fibre Channel frames based on 24-bits of source identification address or destination identification address using a frame select programmable read-only memory (PROM) 88. If desired, “well-known” source or destination addresses per the Fibre Channel specification may be provided to the address filter 86 by a well-known address select 90.

A first-in-first-out (FIFO) buffer 92 buffers bursts of encoded Fibre Channel (PEFC) traffic. In one exemplary embodiment, the traffic is PCM encoded because PCM is an efficient way of serially transferring information. Other types of encoding are also considered part of the invention. The buffer 92 suitably has a minimum size of 256K words. In one embodiment, the buffer 92 has a size of 512K words. If a FIFO overflow occurs, the buffer 92 does not accept any new Fibre Channel data (that is, new Fibre Channel data is ignored) until the buffer 92 has been emptied and an error word has been inserted into the output stream from the buffer 92.

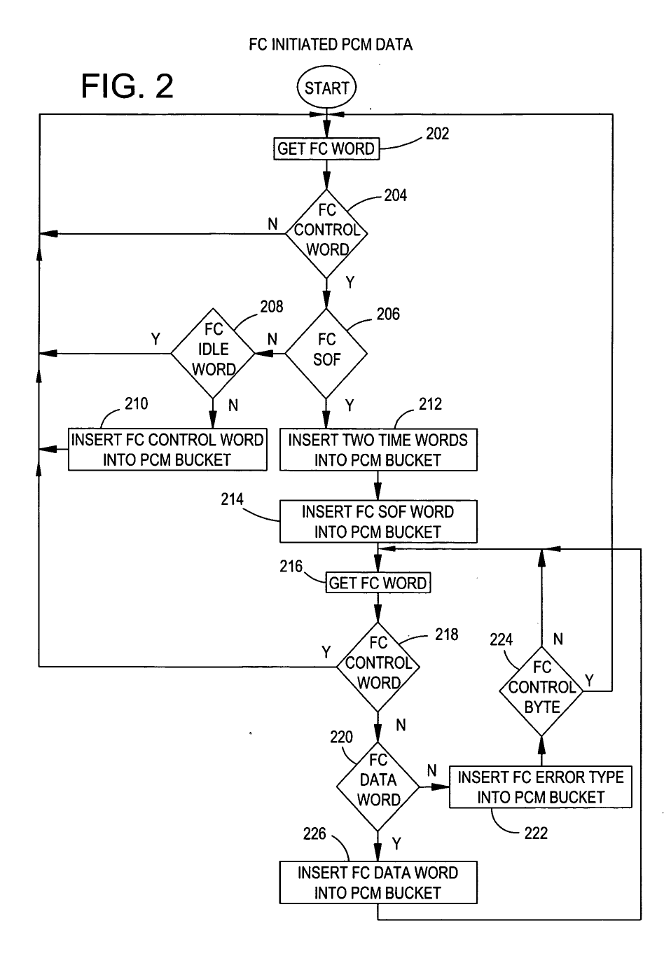

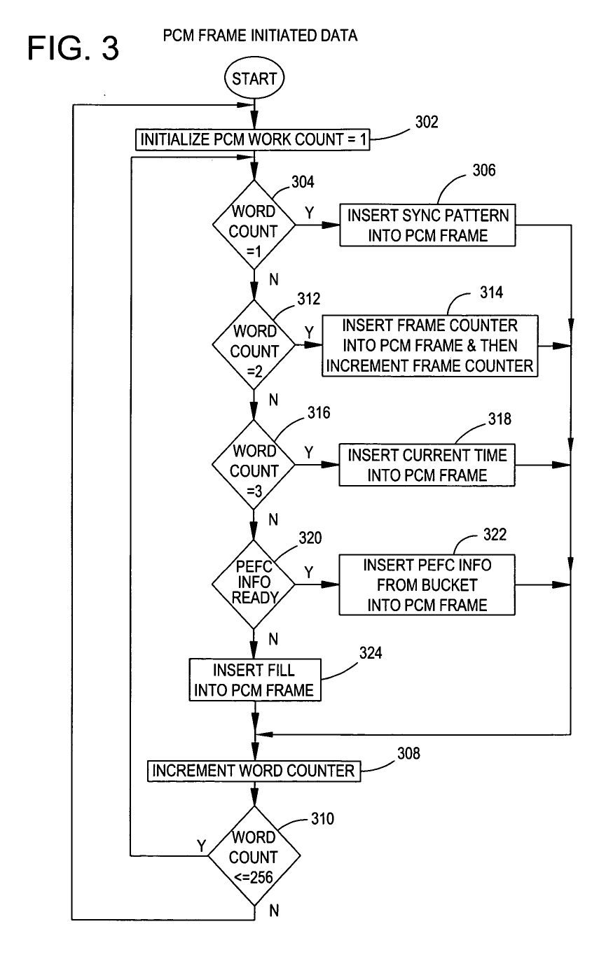

In one exemplary embodiment, the input interface 56 operates as illustrated in FIG. 2 to create packets of PEFC information which are provided to buffer 92. In one exemplary embodiment, the output interface 58 operates as illustrated in FIG. 3 to format the PEFC words received from each of the created packets of the buffers 92 into the PEFC output format by adding frame identification information to each of the created packets. In this exemplary embodiment, the output interface 58 also operates as illustrated in FIG. 3 to provide the PEFC formatted output signals to a recorder 62 and a telemetry system 64. A FIFO buffer 94 is coupled to receive the PEFC output stream from the buffer 92. The buffer 94 provides its output in parallel to a PCM frame generator 96. The PCM frame generator 96 may be programmed to output a single output stream, such as to the recorder 62. Alternately, the PCM frame generator 96 may be programmed to output a dual output stream, such as to two inputs of the recorder 62. Each output may be a fixed word width of 36-bits and a fixed frame length of 256 words. The PCM output streams may be in serial data format. The serial PCM data streams advantageously may be programmable either to contain fill words to provide a continuous clock or to contain a fill word that is inserted every 10 milliseconds for providing a more efficient PCM data frame. However, an output is still provided when no Fibre Channel is available. In addition, merged words from different Fibre Channel inputs may be interleaved.

Output drivers 100 and 102 receive PCM formatted output from the PCM frame generator 96. The drivers 100 and 102 are coupled to provide the output data stream from the output interface 58 to the recorder 62 and/or the telemetry system 64, as desired. The drivers 100 and 102 suitably are RS-422 compatible drivers that are compatible with 26C32 receivers. In one exemplary embodiment, the drivers 100 and 102 provide NRZ-L or RNRZ-L serial data with a 20 Megabps maximum PCM data rate and a dynamic frame rate.

An IRIG time RS-422 receiver and decoder 104 receives IRIG time code from the time code generator 70. The receiver and decoder 104 provides time code signals to the PCM frame generator 96 and to the address filter 86.

Internal Functions—Fibre Channel Interface and Data Format

In one exemplary embodiment, the FCIU 50 accepts a standard FC protocol stream as defined by ANSI X3.230-1994 Fibre Channel—Physical & Signaling Interface (FC-PH). The FCIU uses the standard 8B/10B decoding. Fibre Channel Transmission Words (FCTW) are one of two forms: “K28.5 Dxx.y Dxx.y Dxx.y” or “Dxx.y Dxx.y Dxx.y Dxx.y”. Each FC Input (FCI) interface 56 formats the FCTWs into 36-bit PCM words, an example of which is illustrated in the Appendix.

Fibre Channel Data Filtering

In one exemplary embodiment, each of the four channels is individually enabled and filtered. All “Idle Primitive Signals” are filtered (i.e., removed). Other than “Idles”, “Primitive Signals and Sequences” (which are not part of a frame) are filtered on an “all” or “none” basis. The FCIU 50 is capable of filtering FC frames based on 24-bits of the source or destination ID using frame select PROMs. The FCI interface 56 terminates a captured frame when it detects any “K” character. For a good FC frame, it will be the End-Of-Frame FCTW.

Time Tagging

In one exemplary embodiment, the FCIU 50 inserts two current time words ahead of each collected FC frame. The inserted words corresponds to the detection by the FCIU of the FC Start-Of-Frame (SOF) primitive. See FIG. 2. When using a switch, this time may be significantly different than the actual FC frame time due to buffering inside the switch between ports. If no FC traffic is detected for 10 mS, then these two time words will be inserted without FC frame data. The FCIU inserts a frame counter and the MS time word immediately following the PCM frame sync in the output PCM streams. If two outputs are enabled (“Dual”), then the PCM frame counter and time of both streams are the same in order that data processing may realign them back together. The FCIU synchronizes its internal time to an external time source. If external time is not available, the FCIU time is free-run. An external time synchronization lock is reported in status. See the Appendix and Tables 1 and 2 for an exemplary definition of the time fields for time tagging. The time fields used by the FCIU may be similar to those defined in Chapter 4.7 of the IRIG-106-00 standard (IRIG is the Interrange Instrumentation Group, which is part of the Range Commanders Council (RCC)). Note that IRIG-106 “Binary Weighted Only” time is not supported.

Output PCM Frame Structure

In one exemplary embodiment, the FCIU has two output options, “Single” mode (see the Appendix, Table 4, right column) or “Dual” mode (see the Appendix, Table 3, left and center columns). Each output has a fixed word width of 36 bits and a fixed frame length of 256 words. The serial PCM stream(s) is programmable either to contain fill words to provide a continuous clock or to contain a fill word inserted every 10 mS for providing a more efficient PCM data frame, but still provide an output when no FC data is available. The merged words from different FC inputs may be interleaved. For “Dual” operation, the FCIU ping-pongs the FC data between both outputs with output #1 being the first output of the sequence. The frame sync word is unique for each output.

PCM Word Definitions

In one exemplary embodiment, the MS bit (D₃₅) of the PCM word indicates the “type” of PCM word. Type I is for data extracted from the FC bus. Type II is for data generated by the FCIU.

FC Initiated PCM Data

Referring to FIG. 2, a flow chart is provided illustrating one exemplary embodiment according to the invention by which the input interface 56 operates to create packets of PEFC information which are provided to buffer 92. The process starts by getting a Fibre Channel word at 202 and determining at 204 whether or not the identified word is a control word. If the word being evaluated is not a control word, the process continues to 202 to get subsequent words and to 204 to evaluate whether each word is a control word. When it is determined at 204 that a control word has been identified, the process proceeds to 206 to determine whether or not the identified control word indicates the start of a frame (SOF). If not, the process proceeds to 208 to determine whether the identified control word is an idle word. If it is, the process returns to 202 to look for the next Fibre Channel word. If it is not an idle word and not a start of frame word, the process proceeds to 210 to insert the Fibre Channel control word into a PCM bucket. (e.g., the word is stored in buffers 92 and 94). As an example of this aspect illustrated in one exemplary form, see the Appendix at Section A.1, particularly Section A.1.a (when the word type=1), Section A.1.b and Section A.1.c.

If it is determined at 206 that the word is the start of a frame (SOF) the process proceeds to 212 to insert two time words into the PCM bucket. As an example of this aspect illustrated in one exemplary form, see the Appendix at Section A.2.1, particularly Section A.2.1.a, Section A.2.1.b (when the word type=00), Section A.2.1.b (when the word type=01), and Section A.2.1.c.

From 212, the process proceeds to 214 to insert the FC start of frame word into the PCM bucket. As an example of this aspect illustrated in one exemplary form, see the Appendix at Section A.1, particularly Section A.1.a (when the word type=1), Section A.1.b and Section A.1.c.

The process then continues at 216 looking for the next Fibre Channel word. If the next Fibre Channel word is a control word as determined at 218, the process returns to 202 and then 204 to process the determined control word as noted above. If at 218 the next word is not a control word and is not a data word as determined at 220, the process proceeds to 222 to insert an FC error type into the PCM bucket. As an example of this aspect illustrated in one exemplary form, see the Appendix at Section A.2.1, particularly Section A.2.1.a, Section A.2.1.b (when the word type=11), and Section A.2.1.c.

The process then proceeds to 224 to determine whether the word contains is a Fibre Channel control byte. If it does not, the process then loops back and gets the next word at 216. If at 224 the word is determined to contain a control byte, the process returns to 202 and then 204 to process the control word as noted above.

If at 220 it is determined that the next word is an FC data word, the process proceeds to step 226 to insert an FC data word into the PCM bucket. As an example of this aspect illustrated in one exemplary form, see the Appendix at Section A.1, particularly Section A.1.a (when the word type=0), Section A.1.b and Section A.1.c.

With regard to FIG. 2, it should also be noted that it is possible to append the FC input channel number to all words that are inserted into the PCM bucket. For example, encoding may include adding identification information of each of the Fibre Channel streams.

For simplicity, not all possibilities have been shown in the flow chart of FIG. 2. For example, a Fibre Channel hardware input overflow could occur at any time which would force an overflow indicator into the PCM bucket.

PCM Frame Initiated Data

Referring to FIG. 3, a flow chart is illustrated of one exemplary embodiment of a process according to the invention by which the output interface 58 operates to format the Fibre Channel words received from the buffer 92 into PEFC format by adding PCM frame identification information to provide the PEFC formatted packets to the recorder 62 and the telemetry system 64. The process starts at 302 by initializing the PCM word count to be equal to 1. At 304, the word count is evaluated and if the count equals 1, the process proceeds to 306 to insert a synchronization pattern into the PCM frame. As an example of this aspect illustrated in one exemplary form, see the Appendix at Section A.2.2.a (when the word type=111).

From 306, the process proceeds to 308 to increment the word counter. If the incremented word count is greater than 256 as determined at 310, the process starts over and returns to 302 to initialize the PCM word count to be equal to 1. If at 310 it is determined that the word count is less than or equal to 256, the process proceeds to 304 to further process the next word.

If it is determined at 304 that the word count is not equal to 1 (e.g., if the word counter has been incremented to 2 or more at 308), the process proceeds to 312 to determine whether the word count equals 2. If the word count equals 2, the process proceeds to 314 to insert a frame counter into the PCM frame and increment the frame count. As an example of this aspect illustrated in one exemplary form, see the Appendix at Section A.2.2.a (when the word type=000). The process then proceeds to 308 as noted above to increment the word counter.

If at 312 the word count is not 2, the process proceeds to 316. If at 316 it is determined that the word count equals 3, the process proceeds to 318 to insert the current time into the PCM frame. As an example of this aspect illustrated in one exemplary form, see the Appendix at Section A.2.2.a (when the word type=001). The process then proceeds to 308 as noted above to increment the word counter.

If the word count is not 1 or 2 or 3 as determined at 304, 312 and 316, respectively, the process proceeds to 320 to determine if the PEFC information is ready. If so, then the process proceeds to 322 to insert the PEFC information from the bucket into the PCM frame. The process then proceeds again to 308 as noted above to increment the word counter. If it is determined at 320 that the PEFC information is not ready (e.g., no PEFC information is available), the process proceeds to 324 to insert a fill word (e.g., “D2AAAAAA”) into the PCM frame. As an example of this aspect illustrated in one exemplary form, see the Appendix at Section A.2.2.a (when the word type=010).

It should be noted that all inserted PCM initiated words are type II, sub-type B. It is contemplated that the flow charts may vary according to the type of mode. For example, the flow may be slightly different when using track splitting modes. For simplicity, not all possibilities have been shown in the flow charts. For example, a PCM hardware overflow could occur at any time which would override the insertion of the PEFC information at 322.

Appendix—Example of Word Types

Options for Output PCM Frame Structure:

TABLE 3
Dual Output

| | Output #1 | | Output #2 |
|---|---|---|---|
| 1 | Frame Sync 1 | 1 | Frame Sync 2 |
| 2 | Frame Count i | 2 | Frame Count i |
| 3 | Time Word 1ᵢ | 3 | Time Word 1ᵢ |
| 4 | Merged Wd n | 4 | Merged Wd n + 1 |
| 5 | Merged Wd n + 2 | 5 | Merged Wd n + 3 |
| 6 | Merged Wd n + 4 | 6 | Merged Wd n + 5 |
| . | . | . | . |
| . | . | . | . |
| . | . | . | . |
| 256 | Merged Wd m − 2 | 256 | Merged Wd m − 1 |
| 1 | Frame Sync 1 | 1 | Frame Sync 2 |
| 2 | Frame Count i + 1 | 2 | Frame Count i + 1 |
| 3 | Time Word 1ᵢ₊₁ | 3 | Time Word 1ᵢ₊₁ |
| 4 | Merged Wd m | 4 | Merged Wd m + 1 |
| 5 | Merged Wd m + 2 | 5 | Merged Wd m + 3 |
| 6 | Merged Wd m + 4 | 6 | Merged Wd m + 5 |
| . | . | . | . |
| . | . | . | . |
| . | . | . | . |

TABLE 4
Single Output

| | Output #1 |
|---|---|
| 1 | Frame Sync 1 |
| 2 | Frame Count I |
| 3 | Time Word 1_{I} |
| 4 | Merged Wd n |
| 5 | Merged Wd n + 1 |
| 6 | Merged Wd n + 2 |
| . | . |
| . | . |
| . | . |
| 256 | Merged Wd m-1 |
| 1 | Frame Sync 1 |
| 2 | Frame Count i + 1 |
| 3 | Time Word 1ᵢ₊₁ |
| 4 | Merged Wd m |
| 5 | Merged Wd m + 1 |
| 6 | Merged Wd m + 2 |
| . | . |
| . | . |
| . | . |

TIME FIELDS FOR TIME TAGGING—The bit definitions for the MS (most significant) time field and the LS least significant) time field are shown in Tables 1 and 2, respectively.

TABLE 1
MS Time Field

| | | | | | | | | | | | | | | | | | | | | | | | |
|---|---|---|---|---|---|---|---|---|---|---|---|---|---|---|---|---|---|---|---|---|---|---|---|
| D₂₃ | D₂₂ | D₂₁ | D₂₀ | D₁₉ | D₁₈ | D₁₇ | D₁₆ | D₁₅ | D₁₄ | D₁₃ | D₁₂ | D₁₁ | D₁₀ | D₉ | D₈ | D₇ | D₆ | D₅ | D₄ | D₃ | D₂ | D₁ | D₀ |

| | | | | | | | |
|---|---|---|---|---|---|---|---|
| 1 Day | 10 Hour | 1 Hour | 10 Minute | 1 Minute | 0 | 10 Second | 1 Second |

BCD Weighted

TABLE 2
LS Time Field

| | | | | | | | | | | | | | | | | | | | | | | | |
|---|---|---|---|---|---|---|---|---|---|---|---|---|---|---|---|---|---|---|---|---|---|---|---|
| D₂₃ | D₂₂ | D₂₁ | D₂₀ | D₁₉ | D₁₈ | D₁₇ | D₁₆ | D₁₅ | D₁₄ | D₁₃ | D₁₂ | D₁₁ | D₁₀ | D₉ | D₈ | D₇ | D₆ | D₅ | D₄ | D₃ | D₂ | D₁ | D₀ |

| | | |
|---|---|---|
| 0.1 Second | 0.01 Second | 0.25 or 1.0 Microsecond (See FCI Filter Mode) |

| | |
|---|---|
| BCD Weighted | Binary Weighted |

SECTION A.1—PCM word type I is illustrated in the following Table 5:

(FCTW − D₃₅ = 0) (MSN = 0 − 7)

| | | | | |
|---|---|---|---|---|
| D₃₅ | D₃₄ | D₃₃ | D₃₂ | D₃₁-D₀ |

| | | | |
|---|---|---|---|
| 0 | a | b | C |

SECTION A.1.a—Fibre Channel transmission word type is illustrated in the following Table 6:

| D₃₄ | Description | (MSN) |
|---|---|---|
| 0 | Data Word - Dxx.y Dxx.y Dxx.y Dxx.y | (0-3) |
| 1 | Control Word - Kxx.y Dxx.y Dxx.y Dxx.y | (4-7) |

SECTION A.1.b—Channel number (D₃₅−D₃₄=‘0X_{B}’) is illustrated in the following Table 7:

| D₃₃ | D₃₂ | Description |
|---|---|---|
| 0 | 0 | Data from Channel 1 input |
| 0 | 1 | Data from Channel 2 input |
| 1 | 0 | Data from Channel 3 input |
| 1 | 1 | Data from Channel 4 input |

SECTION A.1.c—8B/10B decoded FCTWs.

SECTION A.2—PCM word type II (FC frame and PCM frame words−D₃₅=1) (MSN=8−F) is illustrated in the following Table 8:

| D₃₅ | D₃₄ | D₃₃-D₀ |
|---|---|---|
| 1 | a | b |

SECTION A.2.a—PCM word type II sub-type is illustrated in the following Table 9:

| D₃₄ | Description |
|---|---|
| 0 | Sub-Type A - Information Associated with FCI Frame |
| 1 | Sub-Type B - Information Associated with PCM Frame |

SECTION A.2.b—Sub-type information.

SECTION A.2.1—The following Table 10 illustrates Sub-Type A (FC Frame−D₃₄=0)

| | | | | | |
|---|---|---|---|---|---|
| D₃₄ | D₃₃ | D₃₂ | D₃₁ | D₃₀ | D₂₉-D₀ |

| | | | |
|---|---|---|---|
| 0 | a | b | c |

SECTION A.2.1.a—Channel Number (D₃₅−D₃₄=‘10_{B}’) is illustrated in the following Table 11:

| D₃₃ | D₃₂ | Description | (MSN) |
|---|---|---|---|
| 0 | 0 | Data associated with Channel 1 input | (5) |
| 0 | 1 | Data associated with Channel 2 input | (9) |
| 1 | 0 | Data associated with Channel 3 input | (A) |
| 1 | 1 | Data associated with Channel 4 input | (B) |

SECTION A.2.1.b—FCIU Data Type is illustrated in the following Table 12:

| D₃₁ | D₃₀ | Description | (NSN) |
|---|---|---|---|
| 0 | 0 | Time Word 1 | (0-3) |
| 0 | 1 | Time Word 2 | (4-7) |
| 1 | 0 | Overflow/Underflow/Reserved | (8-B) |
| 1 | 1 | Error Word | (C-F) |

SECTION A.2.1.c—Data Field—Definitions depend on Data Type as illustrated in the following Tables 13-19:

TABLE 13
Time Word 1 - (D₃₁ -D₃₀ = ‘00_{B}’)

| | | | | | | | | |
|---|---|---|---|---|---|---|---|---|
| D₃₁ | D₃₀ | D₂₉ | D₂₈ | D₂₇ | D₂₆ | D₂₅ | D₂₄ | D₂₃ − D₀ |

| | | | |
|---|---|---|---|
| 0 | 0 | Status A | MS Time |

| | | | | | |
|---|---|---|---|---|---|
| S_{A5} | S_{A4} | S_{A3} | S_{A2} | S_{A1} | S_{A0} |

TABLE 14
Status A

| Status Bits | Description |
|---|---|
| S_{A5} (D₂₉) | Non K28.5 K Character (001) |
| S_{A4} (D₂₈) | Not Used by FC Decoder (010) |
| S_{A3} (D₂₇) | Codeword Violation (100) |
| S_{A2} (D₂₆) | Loss of CRU Bit Lock (101) |
| S_{A1} (D₂₅) | Disparity Error (110) |
| S_{A0} (D₂₄) | Not Used by FC Decoder (111) |

TABLE 15
Time Word 2 - (D₃₁ -D₃₀ = ‘01_{B}’)

| | | | | | | | | |
|---|---|---|---|---|---|---|---|---|
| D₃₁ | D₃₀ | D₂₉ | D₂₈ | D₂₇ | D₂₆ | D₂₅ | D₂₄ | D₂₃ − D₀ |

| | | | |
|---|---|---|---|
| 0 | 1 | Status B | LS Time |

| | | | | | |
|---|---|---|---|---|---|
| S_{B5} | S_{B4} | S_{B3} | S_{B2} | S_{B1} | S_{B0} |

TABLE 16
Status B

| Status Bits | Description |
|---|---|
| S_{B5} (D₂₉) | Word Boundary Error |
| S_{B4} (D₂₈) | Fiber Signal Detect Error |
| S_{B3} (D₂₇) | Undefined |
| S_{B2} (D₂₆) | Undefined |
| S_{B1} (D₂₅) | Undefined |
| S_{B0} (D₂₄) | 10 mS Time Resolution: 0 = 250 nS, 1 = 1 μS |

TABLE 17
Overflow/Underflow - (D₃₁ − D₃₀ = ‘10_{B}’)

| | | | | | De- | |
|---|---|---|---|---|---|---|
| | | | | | scrip- | |
| D₃₁ | D₃₀ | D₂₉ | D₂₈ | D₂₇-D₀ | tion | |
| 1 | 0 | 0 | 0 | 5555555_{H} | Over- | H85555555_{H} |
| | | | | | flow | |
| 1 | 0 | 0 | 1 | AAAAAAA_{H} | Under- | H9AAAAAAA_{H} |
| | | | | | Flow | |
| 1 | 0 | 1 | 0 | (undefined) | Re- | |
| | | | | | served | |
| 1 | 0 | 1 | 1 | (undefined) | Re- | |
| | | | | | served | |

(H = ‘10nn_{B}’ where nn = Chan. #)

TABLE 18
Error Word - (D₃₁ − D₃₀ = ‘11_{B}’)

| D₃₁ | D₃₀ | D₂₉ | D₂₈ | D₂₇-D₁₆ | D₁₅-D₁₂ | D₁₁-D₈ | D₇-D₄ | D₃-D₀ |
|---|---|---|---|---|---|---|---|---|
| 1 | 1 | 0 | 0 | 000 | MSB Info | NMSB Info | NLSB Info | LSB Info |

TABLE 19
“Info” = ‘0xxx_{B}’ where ‘xxx’ is defined as:

| Info Bits | Description |
|---|---|
| 000 | Normal Character |
| 001 | Non K28.5 K Character |
| 010 | Not Used by FC Decoder |
| 011 | K28.5 Character |
| 100 | Codeword Violation |
| 101 | Loss of CRU Bit Lock |
| 110 | Disparity Error |
| 111 | Not Used by FC Decoder |

SECTION A.2.2—The following Table 20 illustrates Sub-Type (PCM Frame−D₃₄=1) (MSN=C−F)

| | | | | |
|---|---|---|---|---|
| D₃₄ | D₃₃ | D₃₂ | D₃₁ | D₃₀-D₀ |

| | | |
|---|---|---|
| 1 | a | B |

SECTION A.2.2.a—Data Type (D₃₅−D₃₄=‘11_{B}’) is illustrated in the following Table 21:

| D₃₃ | D₃₂ | D₃₁ | Description | (MSN) | (NSN) |
|---|---|---|---|---|---|
| 0 | 0 | 0 | Frame Count | (C) | (0-7) |
| 0 | 0 | 1 | Time Word 1 | (C) | (8-F) |
| 0 | 1 | 0 | Fill | (D) | (2) |
| 0 | 1 | 1 | Overflow | (D) | (0) |
| 1 | 0 | 0 | Undefined | (E) | (0-7) |
| 1 | 0 | 1 | Undefined | (E) | (8-F) |
| 1 | 1 | 0 | Undefined | (F) | (0-7) |
| 1 | 1 | 1 | Frame Sync | (F) | (E) |

SECTION A.2.2.b—Data Field—Definitions depend on Data Type as illustrated in the following Tables 22-30:

TABLE 22
Frame Count Word - (D₃₃ − D₃₁ = ‘000_{B}’)

| | | | | | | | | | | |
|---|---|---|---|---|---|---|---|---|---|---|
| D₃₃ | D₃₂ | D₃₁ | D₃₀ | D₂₉ | D₂₈ | D₂₇ | D₂₆ | D₂₅ | D₂₄ | D₂₃-D₀ |

| | | | | |
|---|---|---|---|---|
| 0 | 0 | 0 | Status C | Binary Frame Counter |

| | | | | | | |
|---|---|---|---|---|---|---|
| S_{C6} | S_{C5} | S_{C4} | S_{C3} | S_{C2} | S_{C1} | S_{C0} |

TABLE 23
Status C with Binary Frame Counter = x . . . x0_{b}

| Status Bits | Description |
|---|---|
| S_{C6}-S_{C0} (D₃₀-D₂₄) | ASCII Internal Status Information |
| | (Null terminated string.) |

TABLE 24
Status C with Binary Frame Counter = x . . . x00000001_{b}

| Status Bits | Description |
|---|---|
| S_{C6} (D₃₀) | Undefined |
| S_{C5} (D₂₉) | IRIG LOCK |
| S_{C4} (D₂₈) | PCM Output Mode: 0 = Sngl, 1 = Dual |
| S_{C3} (D₂₇) | FCI #4 Activity (i.e. Frames) |
| S_{C2} (D₂₆) | FCI #3 Activity (i.e. Frames) |
| S_{C1} (D₂₅) | FCI #2 Activity (i.e. Frames) |
| S_{C0} (D₂₄) | FCI #1 Activity (i.e. Frames) |

TABLE 25
Time Word 1 - (D₃₃ − D₃₁ = ‘001_{B}’)

| | | | | | | | | | | |
|---|---|---|---|---|---|---|---|---|---|---|
| D₃₃ | D₃₂ | D₃₁ | D₃₀ | D₂₉ | D₂₈ | D₂₇ | D₂₆ | D₂₅ | D₂₄ | D₂₃-D₀ |

| | | | | |
|---|---|---|---|---|
| 0 | 0 | 1 | Status D | MS Time |

| | | | | | | |
|---|---|---|---|---|---|---|
| S_{D6} | S_{D5} | S_{D4} | S_{D3} | S_{D2} | S_{D1} | S_{D0} |

TABLE 26
Status D

| Status Bits | Description |
|---|---|
| S_{D6 (D}₃₀) | Days Hundreds (2) |
| S_{D5 (D}₂₉) | DaysHundreds (1) |
| S_{D4 (D}₂₈) | Days Tens (8) |
| S_{D3 (D}₂₇) | Days Tens (4) |
| S_{D2 (D}₂₆) | Days Tens (2) |
| S_{D1 (D}₂₅) | Days Tens (1) |
| S_{D0 (D}₂₄) | Days Units (8) |

TABLE 27
Fill - (D₃₃ − D₃₁ = ‘010_{B}’)

| D₃₃ D₃₂ | D₃₁ D₃₀ | D₂₉ | D₂₈ | D₂₇-D₀ | |
|---|---|---|---|---|---|
| 0 1 | 0 0 | 1 | 0 | AAAAAAA_{H} | D2AAAAAAA_{H} |

TABLE 28
Overflow - (D₃₃ − D₃₁ = ‘011_{B}’)

| D₃₃ | D₃₂ | D₃₁ | D₃₀ | D₂₉ | D₂₈ | D₂₇-D₀ | |
|---|---|---|---|---|---|---|---|
| 0 | 1 | 1 | 1 | 0 | 1 | 5555555_{H} | DD5555555_{H} |

Undefined—(D₃₃−D₃₁=‘100_{B}’, ‘110_{B}’, and ‘110_{B}’) These undefined data bits provide capability for other enhancements. For example, these undefined codes could be used for embedding other PCM streams such as IRIG-106 Chapter 4 and 8 or other embedded user data such as digital voice or discretes.

Frame Sync—(D₃₃−D₃₁=‘111_{B}’)

TABLE 29
Output 1 (Leading Frame)

| D₃₃ D₃₂ | D₃₁ | D₃₀ | D₂₉ | D₂₈ | D₂₇-D₄ | D₃-D₀ | |
|---|---|---|---|---|---|---|---|
| 1 1 | 1 | 1 | 1 | 0 | 6B2840 | 0 | FE6B28400_{H} |

TABLE 30
Output 2 (Lagging Frame)

| D₃₃ D₃₂ | D₃₁ | D₃₀ | D₂₉ | D₂₈ | D₂₇-D₄ | D₃-D₀ | |
|---|---|---|---|---|---|---|---|
| 1 1 | 1 | 1 | 1 | 0 | 6B2840 | 1 | FE6B28401_{H} |

The aforementioned encoding scheme provides flexibility to add other capabilities. For example, in a 40-bit PCM word format, the format may be the same as the 36 bit format noted above with the addition of four bits added at the beginning of the word in order to identify 64 FC inputs as opposed to the original 4 FC inputs noted above. It is contemplated that additional frame sync patterns may be added using the undefined bits in order to support more track splitting than the two track splitting described above. Alternatively or in addition, this encoding scheme using the undefined bits may be adapted to other networks such as Ethernet. The PEFC scheme may also be used to bundle the FCN data as a payload for any other type of protocol such as SCSI, TCP/IP, etc.

1. A method of combining multiple data streams of a Fibre Channel network, said method comprising:
encoding the first and second data streams of the Fibre Channel network; and
merging the encoded first and second data streams into a plurality of frames.

2. The method of claim 1 further comprising providing the plurality of frames to a device.

3. The method of claim 2 wherein the device is a recorder.

4. The method of claim 1 further comprising recording the plurality of frames.

5. The method of claim 1 further comprising processing the recorded plurality of frames thereby processing the data of the streams.

6. The method of claim 5 wherein said processing comprises extracting one of the data streams from the recorded frames.

7. The method of claim 1 wherein the encoding comprises time tagging the data.

8. The method of claim 1 wherein the merging comprises merging the encoded data streams into pulse code modulated (PCM) frames.

9. The method of claim 1 further comprising enabling and filtering the received data streams before the merging of the received data streams.

10. The method of claim 1 wherein encoding includes adding identification information to each of the Fibre Channel streams.

11. The method of claim 1 further comprising:
creating packets of information from each of the first and second data streams; and
adding identification information to each of the frames.

12. The method of claim 11 wherein creating packets comprises:
capturing words of each of the data streams;
determining a content of each of the captured words;
formatting each of the captured words according to its determined content.

13. The method of claim 12 wherein the determining comprises determining whether each of the captured words is a control word or a data word.

14. The method of claim 13 wherein the adding comprises inserting a time indicator into the created packet relating to each of the determined control words.

15. The method of claim 12 wherein the determining comprises determining whether each of the captured words is a start of frame word.

16. The method of claim 15 wherein the adding comprises inserting a start of frame indicator into the created packet relating to each of the determining start of frame words.

17. The method of claim 11 wherein the adding identification information comprises at least one of the following: inserting a sync pattern into each of the frames; inserting an increment frame counter into each of the frames; inserting a current time into each of the frames; and inserting encoding information into each of the created frames.

18. A method of combining multiple data streams of a Fibre Channel network, said method comprising:
creating packets of information from each of the first and second data streams by;
capturing words of each of the data streams;
determining a content of each of the captured words; and
formatting each of the captured words according to its determined content;
merging the encoded first and second data streams into a plurality of frames; and
adding identification information to each of the frames.

19. The method of claim 18 wherein the determining comprises determining whether each of the captured words is a control word or a data word.

20. The method of claim 19 wherein the adding comprises inserting a time indicator into the created packet relating to each of the determined control words.

21. The method of claim 18 wherein the determining comprises determining whether each of the captured words is a start of frame word.

22. The method of claim 21 wherein the adding comprises inserting a start of frame indicator into the created packet relating to each of the determining start of frame words.

23. The method of claim 18 wherein the adding identification information comprises at least one of the following: inserting a sync pattern into each of the frames; inserting an increment frame counter into each of the frames; inserting a current time into each of the frames; and inserting encoding information into each of the created frames.

24. A method of combining multiple data streams of a Fibre Channel network, said method comprising:
creating packets of information from each of first and second data streams;
merging the encoded first and second data streams into a plurality of frames; and
adding identification information to each of the frames including at least one of the following: inserting a sync pattern into each of the frames; inserting an increment frame counter into each of the frames; inserting a current time into each of the frames; and inserting encoding information into each of the created frames.

25. A method of combining multiple data streams of a plurality of avionics units networked with a Fibre Channel network having nodes, at least one node having an interface for transmitting at least some of the multiple data streams, said method comprising:
encoding the transmitted multiple data streams of said at least one node of the Fibre Channel network; and
merging the encoded multiple data streams into a plurality of frames.

26. The method of claim 25 further comprising providing the plurality of frames to a device.

27. The method of claim 26 wherein the device is a recorder.

28. The method of claim 25 further comprising recording the plurality of frames.

29. The method of claim 25 further comprising processing the recorded plurality of frames thereby processing the data of the multiple streams.

30. The method of claim 29 wherein said processing comprises extracting one of the data streams from the recorded frames.

31. The method of claim 25 wherein the encoding comprises time tagging the data.

32. The method of claim 25 wherein the merging comprises merging the encoded data streams into pulse code modulated (PCM) frames.

33. The method of claim 25 further comprising enabling and filtering the received data streams before the merging of the received data streams.

34. The method of claim 25 wherein encoding includes adding identification information to each of the Fibre Channel streams.

35. The method of claim 25 further comprising:
creating packets of information from each of the multiple data streams; and
adding identification information to each of the frames.

36. The method of claim 35 wherein the creating packets comprises:
capturing words of each of the data streams;
determining a content of each of the captured words;
formatting each of the captured words according to its determined content.

37. The method of claim 36 wherein the determining comprises determining whether each of the captured words is at least one of a control word and a data word.

38. The method of claim 37 wherein the adding comprises inserting a time indicator into the created packet relating to each of the determined control words.

39. The method of claim 36 wherein the determining comprises determining whether each of the captured words is a start of frame word.

40. The method of claim 39 wherein the adding comprises inserting a start of frame indicator into the created packet relating to each of the determining start of frame words.

41. The method of claim 36 wherein the adding identification information comprises at least one of the following; inserting a sync pattern into each of the frames; inserting an increment frame counter into each of the frames; inserting a current time into each of the frames; and inserting encoding information into each of the created frames.
